(19) United States
(12) Patent Application Publication
(10) Pub. No.: US 2009/0296287 A1
(43) Pub. Date: Dec. 3, 2009

(54) OVERVOLTAGE PROTECTION SYSTEM

(75) Inventors: NING WANG, Shenzhen City (CN); YONG-XING YOU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD, Shenzhen City (CN); HON HAI PRECISION INDUSTRY CO., LTD., Tu-Cheng (TW)

(21) Appl. No.: 12/192,091

(22) Filed: Aug. 14, 2008

(30) Foreign Application Priority Data
May 30, 2008 (CN) 200810301869.4

(51) Int. Cl. H02H 7/00

(52) U.S. Cl. 361/18

(57) ABSTRACT

An overvoltage protection system includes a voltage divider, a compare circuit, and a switch discharge circuit. A voltage regulator module is connected to the switch discharge circuit via the voltage divider. The compare circuit is connected to the switch discharge circuit. When the voltage regulator module outputs an overvoltage, the compare circuit turns on the switch discharge circuit to discharge remaining power in motherboard components and turn off the computer. The overvoltage protection circuit gives a rapid response to overvoltage output from the voltage regulator module, thereby protecting the motherboard components from being damaged.

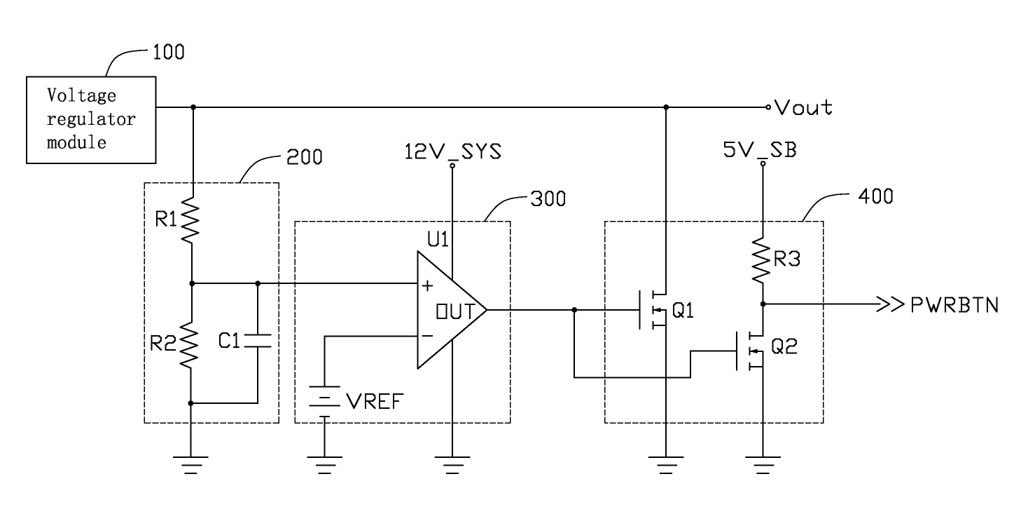

### BACKGROUND

1. Field of the Invention

The present invention relates to overvoltage protection systems and, particularly to an overvoltage protection system for a motherboard of a computer.

2. Description of Related Art

Electronic devices, such as computers, are designed to operate in a certain voltage range, and damage can be caused by voltage that exceeds the maximum voltage the electronic devices are rated for.

What is needed, therefore, is to provide an overvoltage protection system which can prevent the electronic devices from being damaged.

### BRIEF DESCRIPTION OF THE DRAWING

The drawing is a circuit diagram of an overvoltage protection system in accordance with an embodiment of the present invention.

### DETAILED DESCRIPTION

Referring to the drawing, an overvoltage protection system includes a voltage regulator module 100, a voltage divider 200, a compare circuit 300, and a switch discharge circuit 400. The voltage regulator module 100 is capable of supplying power to a motherboard of a computer, and the voltage regulator module 100 is connected to the switch discharge circuit 400 via the voltage divider 200 and the compare circuit 300. The voltage regulator module 100 is also connected to the switch discharge circuit 400. When the voltage regulator module 100 outputs an overvoltage, the overvoltage is divided and sent to the compare circuit 300 by the voltage divider 200, and the compare circuit 300 receives the voltage from the voltage divider 200 and outputs a control signal. The control signal turns on the switch discharge circuit 400 to discharge remaining power in certain motherboard components, and turn off the computer.

The voltage divider 200 includes two resistors R1, R2, and a capacitor C1. A voltage output terminal Vout of the voltage regulator module 100 is grounded via the resistors R1 and R2 connected in series, and the capacitor C1 is connected to the resistor R2 in parallel.

The compare circuit 300 includes a comparator U1. A non-inverting input terminal of the comparator U1 is connected to a node between the resistor R1 and the resistor R2, an inverting input terminal of the comparator U1 is connected to receive a reference voltage VREF, an output terminal OUT of the comparator U1 is connected to the switch discharge circuit 400, a power terminal of the comparator U1 is connected to a 12V system power supply 12V_SYS, and a ground terminal of the comparator U1 is grounded.

The switch discharge circuit 400 includes two metal oxide semiconductor field-effect transistors (MOSFETs) Q1, Q2, and a resistor R3. The MOSFETs Q1, Q2 are N channel metal oxide semiconductor field-effect transistors (NMOSFETs). The NMOSFET sources of the NMOSFETs Q1 and Q2 are grounded, the NMOSFET gates of the NMOSFETs Q1 and Q2 are connected to the output terminal OUT of the comparator U1, the NMOSFET drain of the NMOSFET Q1 is connected to the voltage output terminal Vout of the voltage regulator module 100, the NMOSFET drain of the NMOSFET Q2 is connected to a 5V standby power supply 5V_SB via the resistor R3, and is also connected to a computer power state pin PWRBTN. When the power state pin PWRBTN receives a low level voltage and the computer is running, the computer is turned off. When the power state pin PWRBTN receives a high level voltage, the computer will maintain its current state.

After the computer is turned on, if the voltage output terminal Vout of the voltage regulator module 100 outputs a voltage in a certain voltage range of the motherboard components, the voltage at the non-inverting input terminal of the comparator U1 is lower than the reference voltage VREF, the output terminal OUT of the comparator U1 is at a low level to turn off the NMOSFETs Q1 and Q2, the power state pin PWRBTN is at a high level, the computer maintains its current state, and the voltage regulator module 100 normally supplies power to the motherboard components via the voltage output terminal Vout.

When the voltage output terminal Vout of the voltage regulator module 100 outputs a voltage higher than a maximum voltage the motherboard components are rated for, the voltage at the non-inverting input terminal of the comparator U1 is higher than the reference voltage VREF, the output terminal OUT of the comparator U1 is at a high level, and the NMOSFETs Q1 and Q2 turn on. The turned-on NMOSFET Q1 quickly grounds the voltage output terminal Vout of the voltage regulator module 100, any remaining power in the voltage regulator module 100 supplying to the motherboard components is discharged, thereby preventing damage to the motherboard components. The turned-on NMOSFET Q2 makes the power pin PWRBTN low level, and thus turning the computer off.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An overvoltage protection system for a computer comprising:
a compare circuit;
a voltage divider capable of dividing a voltage output from a voltage regulator module, and sending the voltage to the compare circuit; and
a switch discharge circuit capable of discharging remaining power in motherboard components, and turning off the computer, the voltage regulator module being connected to the switch discharge circuit via the voltage divider, and the compare circuit being connected to the switch discharge circuit and capable of supplying power to motherboard components via a voltage output terminal;
wherein upon a condition that the voltage regulator module outputs an overvoltage, the compare circuit turns on the switch discharge circuit to discharge remaining power in motherboard components and turn off the computer.

2. The system as claimed in claim 1, wherein the voltage divider comprises a first resistor, a second resistor, and a capacitor; the voltage regulator module is grounded via the first and second resistors connected in series, and the capacitor is connected to the second resistor in parallel.

3. The system as claimed in claim 2, wherein the compare circuit comprises a comparator comprising a comparator non-inverting input terminal, a comparator inverting input terminal, a comparator output terminal, a comparator power terminal, and a comparator ground terminal; the comparator non-inverting input terminal is connected to a node between the first and second resistors, the comparator inverting input terminal is connected to receive a reference voltage, the comparator output terminal is connected to the switch discharge circuit, the comparator power terminal is connected to a first power supply, and the comparator ground terminal is grounded.

4. The system as claimed in claim 3, wherein the switch discharge circuit comprises a first N channel metal oxide semiconductor field-effect transistor (NMOSFET), a second NMOSFET, and a third resistor; the first and second NMOSFET sources are grounded, the first and second NMOSFET gates are connected to the comparator output terminal, the first NMOSFET drain is connected to the voltage output terminal of the voltage regulator module, the second NMOSFET drain is connected to a second power supply via the third resistor, and is also connected to the computer power state pin.

5. An overvoltage protection method for a computer, comprising:
providing:
a compare circuit;
a voltage divider capable of dividing a voltage output from a voltage regulator module, and sending the voltage to the compare circuit;
a switch discharge circuit capable of discharging remaining power in motherboard components, and turning off the computer; and
a voltage regulator module, connected to the switch discharge circuit via the voltage divider and the compare circuit, also connected to the switch discharge circuit, capable of supplying power to motherboard components via a voltage output terminal;
turning on the switch circuit by the compare circuit upon a condition that the voltage regulator module outputs an overvoltage;
discharging remaining power in motherboard components; and
turning off the computer by the switch discharge circuit.

6. The method as claimed in claim 5, wherein the voltage divider comprises a first resistor, a second resistor, and a capacitor; the voltage regulator module is grounded via the first and second resistors connected in series, and the capacitor is connected to the second resistor in parallel.

7. The method as claimed in claim 6, wherein the compare circuit comprises a comparator comprising a comparator non-inverting input terminal, a comparator inverting input terminal, a comparator output terminal, a comparator power terminal, and a comparator ground terminal; the comparator non-inverting input terminal is connected to a node between the first and second resistors, the comparator inverting input terminal is connected to receive a reference voltage, the comparator output terminal is connected to the switch discharge circuit, the comparator power terminal is connected to a first power supply, and the comparator ground terminal is grounded.

8. The method as claimed in claim 7, wherein the switch discharge circuit comprises a first N channel metal oxide semiconductor field-effect transistor (NMOSFET), a second NMOSFET, and a third resistor; the first and second NMOSFET sources are grounded, the first and second NMOSFET gates are connected to the comparator output terminal, the first NMOSFET drain is connected to the voltage output terminal of the voltage regulator module, the second NMOSFET drain is connected to a second power supply via the third resistor, and is also connected to the computer power state pin.
